(19) United States
(12) Patent Application Publication
(10) Pub. No.: US 2026/0269948 A1
(43) Pub. Date: Sep. 10, 2026

(54) POLARIZATION-MODULATED COMMUNICATION SYSTEMS.

(71) Applicant: Aloe Semiconductor, Inc., Middletown, NJ (US)

(72) Inventor: Christopher R. Doerr, Middletown, NJ (US)

(21) Appl. No.: 19/556,586

(22) Filed: Mar. 4, 2026

Related U.S. Application Data
(60) Provisional application No. 63/766,904, filed on Mar. 4, 2025.

(51) Int. Cl. H04B 10/532; G02B 27/28; G02F 1/01; H04B 10/50; H04B 10/60

(52) U.S. Cl. CPC H04B 10/532; H04B 10/503; H04B 10/60; G02B 27/283; G02F 1/011

(57) ABSTRACT

A dual-polarization communication system includes a transmitter including: a splitter configured to split light from a laser into a first input light and a second input light, a first phase modulator configured to modulate the first input light with a first data stream to yield a first modulated input light and a second phase modulator configured to modulate the second input light with a second data stream to yield a second modulated input light, the second data stream complementary to the first data stream, and an optical element configured to receive the first modulated input light substantially unmixed with the second modulated input light, and the second modulated input light substantially unmixed with the first modulated input light. The optical element is configured to cause the modulated input lights to have different polarizations, combine the modulated input lights into transmit light, and provide the transmit light into a transmission link.

### CROSS-REFERENCE TO RELATED APPLICATION

This application claims the benefit of priority to U.S. Provisional Patent Application No. 63/766,904 filed on Mar. 4, 2025, the entire contents of which are incorporated by reference herein.

### TECHNICAL FIELD

This present disclosure generally relates to dual-polarization communication systems.

### BACKGROUND

In optical communication systems, multiplexing techniques (such as polarization-division multiplexing (PDM)) can increase communication capacity and/or photon efficiency by multiplexing different signals over different channels (e.g., different polarization modes) for simultaneous transmission through a single fiber.

### SUMMARY

Implementations of the present disclosure are generally directed to a dual-polarization (DP) optical communication system.

In a first general aspect, a dual-polarization (DP) communication system includes a transmitter including: a laser configured to emit light, a splitter configured to split the light from the laser into a first input light and a second input light, a first phase modulator configured to modulate the first input light with a first data stream to yield a first modulated input light and a second phase modulator configured to modulate the second input light with a second data stream to yield a second modulated input light, the second data stream complementary to the first data stream, and an optical element including: a first input configured to receive the first modulated input light substantially unmixed with the second modulated input light, and a second input configured to receive the second modulated input light substantially unmixed with the first modulated input light. The optical element is configured to cause the first modulated input light and the second modulated input light to have different polarizations, combine the first modulated input light and the second modulated input light into transmit light, and provide the transmit light into a transmission link.

Implementations of the first general aspect can have one or more of the following features.

In some implementations, the first phase modulator and the second phase modulator are directly connected to the optical element.

In some implementations, the first phase modulator and the second phase modulator include differential phase-shift keyed modulators.

In some implementations, the transmit light includes a substantially equal combination of the first modulated input light and the second modulated input light.

In some implementations, the first phase modulator includes a first tone marker configured to apply a tone in a bias voltage.

In some implementations, the optical element includes a polarization beamsplitter and rotator.

In some implementations, a path length from the first phase modulator to the optical element is substantially equal to a path length from the second phase modulator to the optical element.

In some implementations, the first general aspect includes a traveling-wave modulator that includes the first phase modulator and the second phase modulator. The traveling-wave modulator includes: a first waveguide configured to receive the first input light; a second waveguide configured to receive the second input light; and a driver configured to: apply a first electric field across the first waveguide to generate the first modulated input light; and apply a second electric field across the second waveguide to generate the second modulated input light.

In some implementations, the first general aspect is integrated on a single chip in silicon photonics.

In some implementations, the first modulated input light is provided into a first optical transmission path and the second modulated input light is provided into a second optical transmission path, and the first optical transmission path and the second optical transmission path are free from electronic control of a relative direct current (DC) phase between the first optical transmission path and the second optical transmission path.

In a second general aspect, a DP communication system includes and transmitter including: a laser configured to emit light, a splitter configured to split the light from the laser into a first input light and a second input light, a first modulator configured to modulate the first input light with a first data stream to yield a first modulated input light and a second modulator configured to modulate the second input light with a second data stream to yield a second modulated input light, the second data stream complementary to the first data stream, and an optical element including a first input configured to receive the first modulated input light substantially unmixed with the second modulated input light, and a second input configured to receive the second modulated input light substantially unmixed with the first modulated input light. The optical element is configured to cause the first modulated input light and the second modulated input light to have orthogonal polarizations, combine the first modulated input light and the second modulated input light into transmit light, and provide the transmit light into a transmission link. The second general aspect includes a receiver including: an input port configured to receive light from the transmission link, at least one second optical element configured to split the light from the transmission link into a first split light provided into a first optical transmission path and a second split light, with a different polarization in the transmission link, provided into a second optical transmission path, and a 2×2 multi-input-multi-output (MIMO) demultiplexer configured to receive light from the first optical transmission path and the second optical transmission path.

Implementations of the second general aspect can include one or more of the following features.

In some implementations, the first modulator and the second modulator are directly connected to the optical element.

In some implementations, the transmit light includes a substantially equal combination of the first modulated input light and the second modulated input light.

In some implementations, the first modulator comprises a first tone marker configured to apply a tone in a bias voltage.

In some implementations, the optical element includes a polarization beamsplitter and rotator.

In some implementations, the at least one second optical element includes a polarization beamsplitter and rotator.

In some implementations, the receiver includes: a pair of photodetectors including (i) a first photodetector configured to detect a first demultiplexed output from the optical 2×2 MIMO demultiplexer and output a first electrical signal into a first electrical transmission path, and (ii) a second photodetector configured to detect a second demultiplexed output from the optical 2×2 MIMO demultiplexer and output a second electrical signal into a second electrical transmission path.

In a third general aspect, performing DP transmission includes: generating light using a laser; splitting the light from the laser into a first input light and a second input light; modulating the first input light with a first data stream to yield a first modulated input light and modulating the second input light with a second data stream to yield a second modulated input light, the second data stream complementary to the first data stream; receiving the first modulated input light substantially unmixed with the second modulated input light and receiving the second modulated input light substantially unmixed with the first modulated input light; causing the first modulated input light substantially unmixed with the second modulated input light and the second modulated input light substantially unmixed with the first modulated input light to have orthogonal polarizations; combining the first modulated input light and the second modulated input light into transmit light; and providing the transmit light into a transmission link.

Implementations of the third general aspect can include one or more of the following features.

In some implementations, the transmit light includes a substantially equal combination of the first modulated input light and the second modulated input light.

In some implementations, modulating the first input light and modulating the second input light occurs over substantially equal path lengths.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 illustrates an example of a dual-polarization (DP) communication system.

FIG. 2 illustrates an example of a DP communication system.

FIG. 3 illustrates an example of an optical polarization demultiplexer.

FIG. 4 is a flow chart showing operations of performing DP transmission.

FIG. 5 illustrates an example of a DP communication system.

### DETAILED DESCRIPTION

Systems and methods disclosed provide dual-polarization (DP) optical transmission systems. In a DP optical transmission system, two signals are multiplexed and transmitted using two different polarizations of light. In a differential dual-polarization (DP) link, an optical signal and its complementary signal are transmitted in orthogonal polarizations in an optical fiber. At the receiving end, the signal is polarization demultiplexed using a tracking, endless polarization demultiplexer and sent to a differential receiver. The DP link can achieve better performance than a single-polarization link.

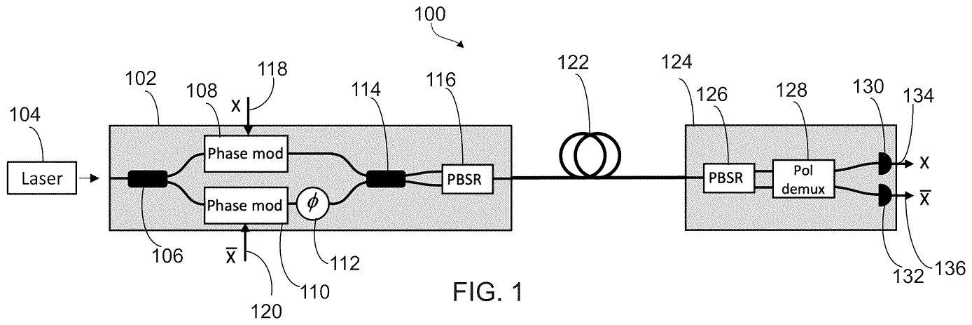

FIG. 1 illustrates an example of DP communication system that generates an optical signal and its complementary signal and transmits a mixed signal thereof.

The DP communication system 100 includes a transmitter 102 that includes a laser 104, an optical splitter 106, a first phase modulator 108, a second phase modulator 110, a phase shifter 112, an optical coupler 114, and a polarization beamsplitter rotator 116. The optical splitter 106, the phase modulators 108, 110, the phase shifter 112, and the optical coupler 114 may be implemented as a Mach-Zehnder interferometer modulator (MZM).

The optical splitter 106 is configured to split the light from the laser 104 into a first input light and a second input light. The first phase modulator 108 is configured to modulate the first input light with a first data stream 118 to yield a first modulated input light. The second phase modulator 110 is configured to modulate the first input light with a second data stream 120 to yield a second modulated input light. The first data stream 118 modulates with a signal X, and the second data stream 120 modulates with a signal X, such that the first and second modulated light are complementary (one is an inverted copy of the other). Consistent with the well-understood configuration of MZMs, the first phase modulator 108 and the second phase modulator 110 of the transmitter 102 are biased at quadrature by setting φ=π/2+m2π using the phase shifter 112, where m is any integer,). The two outputs are provided to the optical coupler 114, which outputs two optical signals that are each a mixed optical signal of the first modulated light and the second modulated light shifted by the phase φ. The polarization beamsplitter rotator 116 includes two inputs configured to receive the two optical signals from the optical coupler 114. The polarization beamsplitter rotator (PBSR) 116 rotates one of the two optical signals to the orthogonal polarization and combines the two optical signals with orthogonal polarizations into transmit light that is provided into a transmission link 122.

At a receiver 124, the transmit light from the transmission link 122 enters a second polarization beamsplitter rotator 126 configured to split the transmit light into a first split light provided to a first optical transmission path and a second split light provided into a second optical transmission path. The second split light had a different polarization from the first split light in the transmission link 122. For example, in some implementations, the first split light and the second split light had orthogonal polarizations in the transmission link 122.

The two signals from the second polarization beamsplitter rotator 126 enter a polarization multi-input-multi-output (MIMO) demultiplexer 128. The polarization MIMO demultiplexer 128 is configured to extract a first demultiplexed signal 134 and a second demultiplexed signal 136.

The polarization MIMO demultiplexer 128 is configured to receive the first split light from the first optical transmission path and the second split light from the second optical transmission path. A first photodetector 130 is configured to detect the first demultiplexed output from the polarization MIMO demultiplexer 128 and output a first electrical signal into a first electrical transmission path to output a first demultiplexed signal. A second photodetector 132 is configured to detect a second demultiplexed output from the polarization MIMO demultiplexer 128 and output a second electrical signal into a second electrical transmission path to output a second demultiplexed signal. The first and second demultiplexed signals can represent the signals X and X̅, respectively.

This disclosure describes DP communication systems with a simpler configuration than the system shown in FIG. 1. For example, in some implementations, the output coupler (e.g., optical coupler 114) can be omitted from the transmitter. In some implementations, the transmitter does not include a direct current (DC) phase bias, φ, or associated monitoring and control. The omission of the output coupler (optical coupler 114) and/or phase bias (phase shifter 112) can save insertion loss and control electronics. For example, the phase bias may require monitor photodiodes used in a feedback loop, control circuitry, and/or the like, and the omission of these elements can provide cost reductions, improved spatial efficiency, power consumption reductions, etc. As another example, the output coupler may be associated with insertion loss that is avoided if the output coupler is omitted. As another advantage of some implementations of the present disclosure in comparison to the system of FIG. 1, polarization-dependent loss (PDL) may not significantly impact differential detection in a DP communication configuration that does not contain the output coupler (e.g., optical coupler 114). However, in the FIG. 1 configuration, PDL in the transmitter may reduce the common-mode rejection in the differential detection.

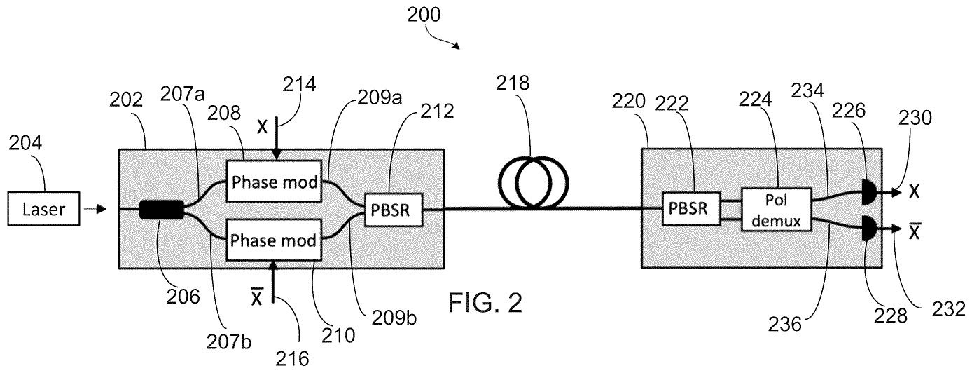

FIG. 2 illustrates an example of a DP communication system according to some implementations of the present disclosure. For development of the DP communication system of FIG. 2, it has been recognized that effective differential transmission and reception may be performed even without inclusion of a DC phase bias and/or output coupler. The DC phase bias and/or output coupler may be included in differential DP transmitters because these elements are included in MZMs. However, surprisingly, DP communication based on differential transmission and reception has been found to be effective when one or both of these elements are omitted.

A DP communication system 200 shown in FIG. 2 includes a transmitter 202 that includes a laser 204, an optical splitter 206, a first phase modulator 208, a second phase modulator 210, and a first polarization beamsplitter rotator 212.

The laser 204 can be any suitable type of laser, for example, a laser diode. The optical splitter 206 is configured to split the light from the laser 204 into a first input light and a second input light provided into an optical transmission path 207a and an optical transmission path 207b, respectively. The first phase modulator 208 is configured to modulate the first input light with a first data stream 214 to yield a first phase-modulated input light provided into a first optical transmission path 209a. The second phase modulator 210 is configured to modulate the second input light with a second data stream 216 to yield a second phase-modulated input light provided into a second optical transmission path 209b. The second data stream 216 is complementary to the first data stream 214. Accordingly, in some implementations, the first and second modulated light are complementary (one is an inverted copy of the other). The transmitter 202 accordingly implements phase-shifted keyed transmission. In some implementations, the first phase modulator 208 and the second phase modulator 210 are differential modulators.

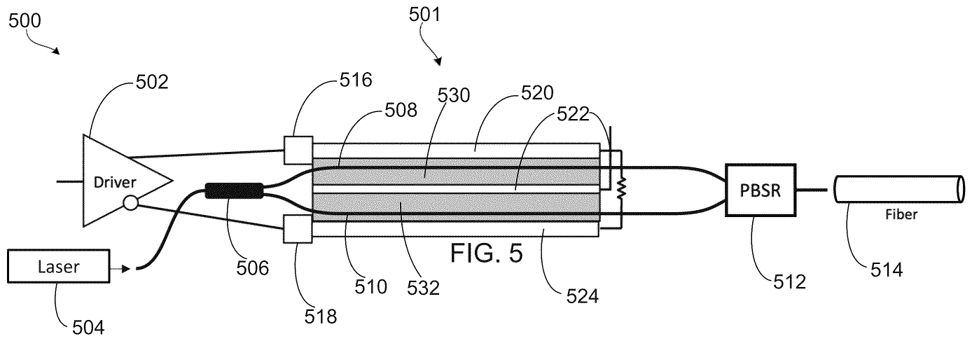

In some implementations, the first phase modulator 208 includes a first tone marker configured to insert a first tonal signature within the first modulated input light (e.g., to modulate the first input light with the first tonal signature). In some implementations, the first phase modulator 208 includes a first tone marker configured to apply the tone in a bias voltage. For example, the bias voltage can be applied through a DC bias connection 522, as shown in FIG. 5. In some implementations, the second phase modulator 210 includes a second tone marker configured to insert a second tonal signature within the second modulated input light. For example, the second tone marker can be configured to apply the tone in a bias voltage, such as the same DC bias connection 522 (or other suitable DC bias connection) through which the first tone marker may be applied. The first tonal signature and/or the second tonal signature are low-frequency tones, and can have different tone frequencies for the two polarizations. For example, the first tonal signature can be transmitted at a 1-MHz frequency, and the second tonal signature can be transmitted at a 2-MHz frequency. The modulation depths of the tonal signatures are a fraction of the signal average power. The first and/or second tonal signature (if included) can be used in some implementations of the polarization demultiplexer 224 (discussed below) to aid demultiplexing and recovery of the first and second demultiplexed electrical signals 230, 232. In some implementations, a common-mode phase modulation signal is used as the tone marker (e.g., the same signal is applied to the first and second phase modulators 208 and 210). This can be accomplished by modulating the bias voltage of the differential modulator.

The phase modulators 208, 210 can include, for example, depletion modulators, ring-resonator modulators, or another suitable modulator type.

In some implementations, as shown in FIG. 2, the first polarization beamsplitter rotator 212 includes a first input configured to receive the first modulated input light from the first phase modulator 208 through the first optical transmission path 209a, substantially unmixed with the second modulated input light. The first polarization beamsplitter rotator 212 includes a second input configured to receive the second modulated input light substantially unmixed with the first modulated input light from the second phase modulator 210, though the second optical transmission path 209b. For example, the first and second modulated input light, which are mixed by the optical coupler 114 in FIG. 1, may be substantially unmixed in the absence of an output coupler. For example, the first polarization beamsplitter rotator 212 can be directly connected to the modulators 208, 210. As noted above, however, the scope of this disclosure is not limited to this configuration. For example, in some implementations, the first modulated input light is substantially mixed with the second modulated input light before being provided to the first polarization beamsplitter rotator 212, and/or the second modulated input light is substantially mixed with the first modulated input light before being provided to the first polarization beamsplitter rotator 212. For example, the DP communication system 200 can include an output coupler (e.g., with the configuration shown in FIG. 1 for the optical coupler 114) without departing from the scope of this disclosure.

Although the example of FIG. 2 shows a polarization beamsplitter rotator 212 being used as an optical element to polarization-modify and combine light, other types of optical polarization-combing elements can be used, including passive photonic integrated devices such as a polarization splitting grating coupler (PSGC).

In some implementations, the optical path lengths 209a and 209b from the outputs of the phase modulators 208, 210 to the first polarization beam splitter rotator 212 can be substantially equal. In some implementations, the first optical transmission path 209a and the second optical transmission path 209b are free from electronic control of a relative DC phase between the paths 209a and 209b. For example, optical transmission paths between the optical splitter 206 and the first polarization beamsplitter rotator 212 (in the example of FIG. 2, optical transmission paths 207a, 207b, 209a, 209b) can be free from electronic control of a relative DC phase between the paths 209a and 209b. For example, there can be no electronic control of the DC differential phase between light provided onto the optical transmission paths 207a, 207b and provided into the first polarization beamsplitter rotator 212. For example, the DP communication system 200 can omit the phase shifter 112 that, in the configuration of FIG. 1, causes a DC phase bias between the first and second modulated input light. However, the scope of this disclosure is not limited thereto. For example, in some implementations, the first modulated input light and the second modulated input light, as received by the first polarization beamsplitter rotator 212 do not have a common phase or a stable phase. For example, the DP communication system 200 can include a phase shifter (e.g., with the configuration shown in FIG. 1 for the phase shifter 112) without departing from the scope of this disclosure.

The first polarization beamsplitter rotator 212 (configured as a combiner) is configured to cause the first modulated input light and the second modulated input light to have different polarizations. For example, the first polarization beamsplitter rotator 212 can cause the first and second modulated input light to have orthogonal polarizations. For example, the first polarization beamsplitter rotator 212 can rotate a polarization of the first modulated input light or the second modulated input light by 90°. The first polarization beamsplitter rotator 212 is configured to combine the first modulated input light and the second modulated input light (with the different polarizations) into transmit light and provide the transmit light into a transmission link 218. The transmission link 218 can include, for example, an optical fiber. In some implementations, the transmit light includes a substantially equal combination of the first modulated input light and the second modulated input light.

A receiver 220 is configured to receive the transmit light and process the transmit light using a polarization demultiplexer to recover the first data stream 214 and the second data stream 216. The recovered data streams can be used to, for example, obtain a low-loss, low-noise signal of the first data stream 214, using any suitable differential signal approach. The receiver in the DP communication system 200 is an example of a suitable receiver, but it will be understood that other receiver configurations are within the scope of this disclosure.

At the receiver 220, the transmit light from the transmission link 218 enters a second polarization beamsplitter rotator 222 configured to split the transmit light into a first split light provided into a first optical transmission path and a second split light provided into a second optical transmission path. The second split light had a different polarization from the first split light in the transmission link 218. After the second polarization beamsplitter rotator 222, both split lights have the same polarization. In some implementations, the first split light and the second split light had orthogonal polarizations in the transmission link 218.

The two signals from the second polarization beamsplitter rotator 222 enter a polarization multi-input-multi-output (MIMO) demultiplexer 224. The polarization MIMO demultiplexer 224 is configured to receive the first split light from the first optical transmission path and the second split light from the second optical transmission path. The polarization MIMO demultiplexer 224 is configured to extract a first demultiplexed optical signal 234 and a second demultiplexed signal 236. The first and second demultiplexed optical signals 234, 236 can represent recovered versions of the first modulated input light and the second modulated input light respectively.

A first photodetector 226 is configured to detect the first demultiplexed optical signal 234 from the polarization MIMO demultiplexer 224 and output a first demultiplexed electrical signal 230 into a first electrical transmission path. A second photodetector 228 is configured to detect the second demultiplexed optical signal 236 from the polarization MIMO demultiplexer 224 and output a second demultiplexed electrical signal into a second electrical transmission path. The first and second demultiplexed electrical signals 230, 232 can represent recovered versions of the first and second data streams 214, 216 (X and X̅), respectively. In some implementations, the first and second demultiplexed electrical signals 230, 232 can be further processed (by the receiver 220 and/or by another component), e.g., to reduce loss and/or noise in X using X.

As noted above, the DP communication system 200 advantageously provides substantially unmixed modulated light into the first polarization beamsplitter rotator 212, e.g., rather than mixing modulated light into a coupler first. The DP communication system 200 also advantageously omits a DC phase bias between modulated light signals in the transmitter 202. Providing this configuration can advantageously simplify transmitter design, reduce loss (e.g., PDL and/or insertion loss), reduce power consumption, and/or provide other advantages.

Although FIG. 2 illustrates an example of a receiver 220 in which the polarization demultiplexer is an optical polarization demultiplexer, the scope of this disclosure is not limited thereto, and receivers within the scope of this disclosure can implement optical polarization demultiplexing, electrical polarization demultiplexing, and/or a combination thereof. In some implementations, the DP communication system 200 is integrated on a single chip in silicon photonics.

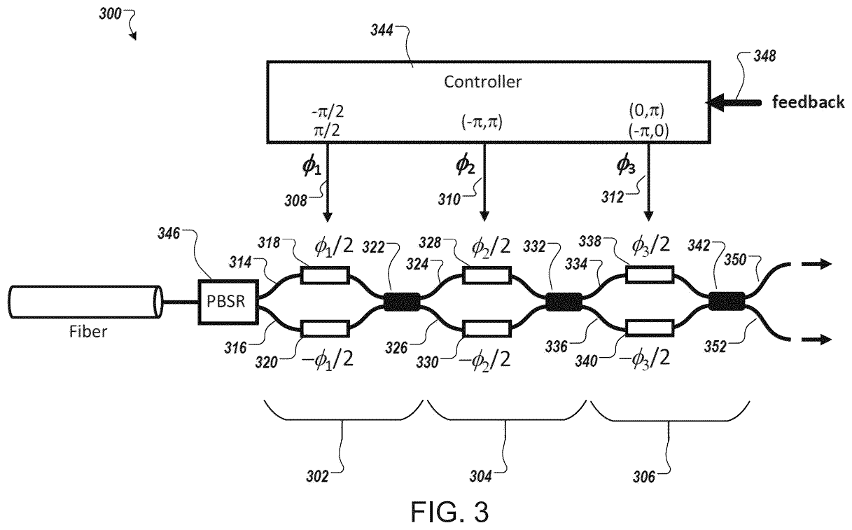

FIG. 3 illustrates an example of a polarization demultiplexer 300 receiving light that has traveled through a fiber and a splitter, according to some implementations of the present disclosure.

The polarization demultiplexer 300 can be implemented as a part of a receiver (e.g., receiver 220 in FIG. 2, such as for the polarization demultiplexer 224). In some implementations, polarization demultiplexer 300 is implemented via integrated photonics which can reduce costs compared to bulk optics.

The polarization demultiplexer 300 includes three stages (302, 304, and 306) of phase shifting. Each stage is controlled by a phase shift control signal. For example, the first stage 302 is controlled by a first control signal 308, the second stage 304 is controlled by a second control signal 310, and the third stage 306 is controlled by a third control signal 312. Each control signal controls the amount of phase shift that is implemented in the respective phase shifting stage.

In the example of FIG. 3, each stage has a phase shifter and a 2×2 coupler that operate on a pair of optical transmission paths. For example, the first stage 302 has pair of transmission paths 314 and 316, optical phase shifting elements 318 and 320 (together forming a differential phase shifter), and a 2×2 coupler 322. Similarly, the second stage 304 has a pair of transmission paths 324 and 326, optical phase shifting elements 328 and 330 (together forming a differential phase shifter), and a 2×2 coupler 332. Finally, the third stage 306 has a pair of transmission paths 334 and 336, optical phase shifting elements 338 and 340 (together forming a differential phase shifter), and a 2×2 coupler 342.

The phase shifters can be thermo-optic (thermo-optic phase shifter, TOPS), electro-optic (electro-optic phase shifter, EOPS), or other types. The TOPS generally have the slowest response time but can be sped up by covering with metal and/or shortening the distance to the heat sink. The power consumption of the TOPS can be reduced by having the optical transmission path pass through the heated region multiple times. The EOPS can operate on, for example, current injection, carrier depletion, or the Pockels effect. Each phase shifter can include multiple sections, such as a section with a phase shifter type that has a fast response time but more power consumption and a section with a phase shifter type that has a slow response time but reduced power consumption. The 2×2 couplers can be, for example, implemented by directional couplers, multi-mode interference couplers, or adiabatic couplers.

As mentioned above, the three stages (302, 304, 306) of the polarization demultiplexer 300 are controlled within specific ranges or values of operations in a coordinated manner, so as to ensure that the polarization demultiplexer 300 can achieve an “endless” property of demultiplexing without requiring a reset of any of the phase shifters. In particular, in the example of FIG. 3, the first control signal φ₁ for the first stage 302 is digital, with a value of either −π/2 or +π/2. The second control signal φ₂ for the second stage 304 can be analog or digital, operating over a continuous or discrete set of values between −π and +π. The third control signal φ₃ for the third stage 306 can be analog or digital, operating over a continuous or discrete set of values within a range that depends on the first control signal φ₁, namely operating between 0 and +π when φ₁ is −π/2 and operating between −π and 0 when φ₁ is +π/2.

During operation of the polarization demultiplexer 300, light that has traveled through a fiber first enters the splitter, such as polarization beamsplitter rotator 346, which splits the input light into the two optical transmission paths 314 and 316. The fiber can be the link 218, and the polarization beamsplitter rotator 346 can be the polarization beamsplitter rotator 222. The polarization beamsplitter rotator 346 splits the input light into two polarizations and rotates one of the polarizations so that both outputs of the polarization beamsplitter rotator 346 are in the same polarization. Thus, although path 314 contains light that was in one polarization when it entered the polarization beamsplitter rotator 346 and path 316 contains light that was in the orthogonal polarization when it entered the polarization beamsplitter rotator 346, once in paths 314 and 316, the light in both paths 314 and 316 are in the same polarization. Although the example of FIG. 3 shows the splitter implemented by polarization beamsplitter rotator 346, other types of splitters can be used, including passive photonic integrated devices such as a polarization splitting grating coupler (PSGC).

The split input light enters the two optical transmission paths 314 and 316 of the first stage 302, and undergo relative phase shifts through phase shifting elements 318 and 320, such that light in one optical transmission path is phase-shifted by an amount φ₁ relative to light in the other optical transmission path. The amount of this relative phase shift φ₁ is controlled by the control signal 308. The phase-shifted light in the two optical transmission paths then enter a 2×2 coupler 322 which combines the relative phase-shifted light. This process repeats through the second stage 304 and the third stage 306, undergoing different phase shifts controlled by control signals φ₂ (310) and φ₃ (312).

A controller 344 controls the amount of relative phase shift in the three stages 302, 304, and 306 via the control signals 308, 310, and 312. In scenarios of closed-loop feedback, this control can be based on feedback information 348 which can be, for example, a measurement of an error in the received signal. For example, the feedback information 348 can include one or both demultiplexed electrical signals 230, 232, and/or one or more signals that are based on the signals 230 and/or 232. As such, as an example, the feedback information 348 can include a measurement of error between the first demultiplexed electrical signal 230 and the first data stream 214. Although FIG. 3 shows the controller 344 as part of the polarization demultiplexer 300, in some implementations, the controller 344 may be implemented separately in a receiver (as another component in receiver 220 of FIG. 2).

The polarization demultiplexer 300 compensates for random birefringence changes which rotate the polarizations of light, caused by distortions introduced by the optical communication system. In addition to compensating for phase shifts, a demultiplexer can also be designed to compensate for other non-idealities, such as polarization dependent loss (PDL). While PDL may be negligible in most short fiber-optic links, as the length of the fiber increases, PDL can have a more substantial impact on proper reception of the optical signals. The transmitter configuration shown in FIG. 2 can advantageously reduce PDL by reducing or eliminating optical mixing between the data stream and its complement.

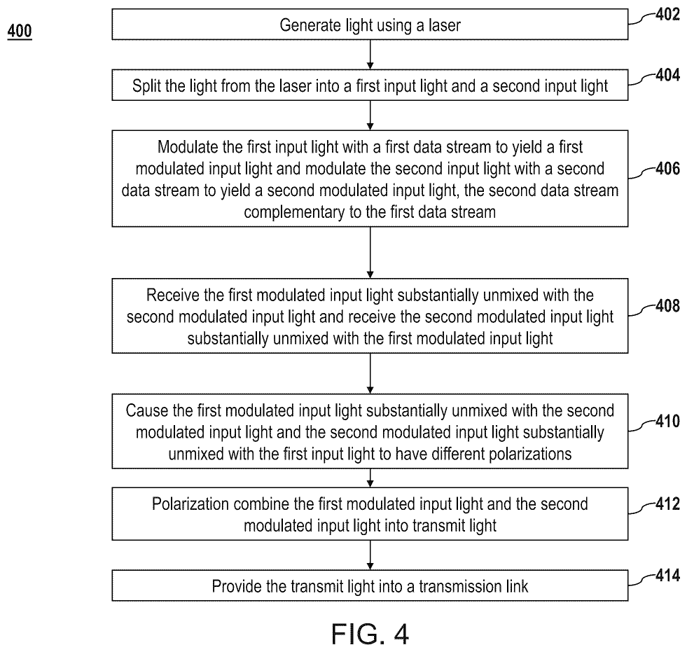

FIG. 4 is a flow chart showing operations in an example process 400 of performing DP transmission, according to some implementations of the present disclosure. The process 400 can be used to perform DP transmission in a DP communication system, such as the DP communication system 200 of FIG. 2. Accordingly, the operations of the process 400 can be performed using the transmitter components described with respect to the transmitter 202.

In step 402, light is generated using a laser. In step 404, the light is split from the laser into a first input light and a second input light. In step 406, the first input light is modulated with a first data stream to yield a first modulated input light and the second input light is modulated with a second data stream to yield a second modulated input light. The second data stream is complementary to the first data stream. In step 408, the first modulated input light, substantially unmixed with the second modulated input light, is received and the second modulated input light, substantially unmixed with the first modulated input light, is received. In some implementations, the first modulated input light and the second modulated input light have a common DC phase (e.g., are phase-matched). In step 410, the first modulated input light, substantially unmixed with the second modulated input light, and the second modulated input light, substantially unmixed with the first modulated input light, are caused to have different polarizations. In step 412, the first modulated input light and the second modulated input light are polarization combined into transmit light. In step 414, the transmit light is provided to a transmission link.

FIG. 5 illustrates an example of a differential DP transmitter 500 using a traveling-wave modulator, according to some implementations of the present disclosure (e.g., the transmitter of FIG. 2). The differential DP transmitter 500 is an example of the transmitter 202 of FIG. 2.

The differential DP transmitter 500 includes a driver 502, a laser 504, and an optical splitter 506. At the input of a modulator 501, the optical splitter 506 splits input light from the laser 504 into a first optical transmission path 508 and a second optical transmission path 510. The first and second optical transmission paths 508, 510 extend through, or as, first and second waveguides 530, 532, respectively. The waveguides 530, 532 can include integrated optical waveguides, such as rib waveguides. At the output of the modulator 501, a polarization beamsplitter rotator 512 combines light output from the first optical transmission path 508 and the second optical transmission path 510 and provides the light to an optical fiber 514 (an example of the link 218).

The driver 502 is configured to provide a differential pair of signals. The modulator 501 uses a travelling wave configuration in which voltages applied at terminals 516 and 518 create an electrical signal that propagates along radio frequency (RF) transmission lines 520, 524 terminated at an RF termination resistance. The electrical signals in the RF transmission lines 520, 524 travel at the same speed as and induce electro-optic modulation in the light that propagates along the first optical transmission path 508 and the second optical transmission path 510. The applied voltages induce a phase shift in the light that propagates in one or both of the optical transmission paths 508 and 510. For example, in some implementations, the modulator 501 is a depletion modulator, and the applied voltages induce changes in depletion widths of semiconductor junctions included in one or both of the first and second waveguides 530, 532, by applying electric fields across the semiconductor junctions. Accordingly, the modulator 501 implements the phase modulators 208, 210 shown in FIG. 2. The phase modulators can have residual amplitude modulation without departing from the scope of this disclosure.

In some implementations, in accordance with the description of FIG. 2, the phase shift can be differential, with the phase shift magnitude being equal and the phase shift sign being opposite between the optical transmission paths 508 and 510. For example, the driver 502 can drive terminal 516 with a signal X (the first data stream 214) and can drive terminal 518 with a signal X̅ (the second data stream 216, the complement of X). The driver 502 can further drive the terminals 516, 518 with a carrier signal.

In an MZM configuration, the outputs of the optical transmission paths 508, 510 may be coupled to cause constructive or destructive interference, converting the phase shifts of the modulator into amplitude modulations. However, in some implementations according to the present disclosure, as shown in FIGS. 2 and 5, this coupling, or mixing, may be omitted (e.g., by providing the outputs of the optical transmission paths 508, 510 directly into the polarization beamsplitter rotator 512), to provide for effective, low-loss DP differential transmission by the transmitter 500. In some implementations, the DC phase shift of the inputs to the polarization beamsplitter rotator 512 can be substantially zero (e.g., the two light signals received at the polarization beamsplitter rotator 512 can have a common DC phase), e.g., by omitting a DC phase shifter that may be included in MZM configurations. For example, in some implementations, the differential DP transmitter 500 is free from, or does not include, electronic control of a DC differential phase between light on the two optical transmission paths provided into the polarization beamsplitter rotator 512. For example, the phase shifter 112, and analogous elements, can be omitted from the differential DP transmitter.

In some implementations, the physical lengths of the optical transmission paths 508 and 510 can be the same to provide zero inherent differential phase shift.

A direct current (DC) bias connection 522 can be connected between the two optical transmission paths 508 and 510. The DC bias connection 522 is implemented such that the optical transmission paths 508 and 510 remain below significant forward bias (e.g., reverse bias), even when data signals applied at the terminals 516 and 518 vary between logical 1 and logical 0. A marker tone may be applied to bias connection 522 to facilitate polarization demultiplexing.

The examples of architectures of optical and electrical systems described herein are not exhaustive. For example, extra optical and/or electrical components can be included in the transmitters and receivers described herein without departing from the scope of this disclosure, such as optical and/or electrical filters, amplifiers/attenuators, splitters, couplers, etc. Moreover, in some implementations, one or more optical and/or electrical component shown in the described transmitters and receivers can be omitted, without departing from the scope of this disclosure. In addition, unless otherwise indicated, signals and light described as being “from” a component need not be directly from the component but, rather, can have been processed in one or more ways. For example, an output received “from” a demultiplexer need not be the direct output from the demultiplexer but may have been amplified, attenuated, filtered, etc., before being received.

While this disclosure contains many specific implementation details, these should not be construed as limitations on the scope of any invention or of what may be claimed, but rather as descriptions of features that may be specific to particular implementations of particular inventions. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results.

What is claimed is:

1. A dual-polarization (DP) communication system, comprising:
a transmitter comprising:
a laser configured to emit light,
a splitter configured to split the light from the laser into a first input light and a second input light,
a first phase modulator configured to modulate the first input light with a first data stream to yield a first modulated input light and a second phase modulator configured to modulate the second input light with a second data stream to yield a second modulated input light, the second data stream complementary to the first data stream, and
an optical element comprising:
a first input configured to receive the first modulated input light substantially unmixed with the second modulated input light, and
a second input configured to receive the second modulated input light substantially unmixed with the first modulated input light,
wherein the optical element is configured to cause the first modulated input light and the second modulated input light to have different polarizations, combine the first modulated input light and the second modulated input light into transmit light, and provide the transmit light into a transmission link.

2. The DP communication system of claim 1, wherein the first phase modulator and the second phase modulator are directly connected to the optical element.

3. The DP communication system of claim 1, wherein the first phase modulator and the second phase modulator comprise differential phase-shift keyed modulators.

4. The DP communication system of claim 1, wherein the transmit light comprises a substantially equal combination of the first modulated input light and the second modulated input light.

5. The DP communication system of claim 1, wherein the first phase modulator comprises a first tone marker configured to apply a tone in a bias voltage.

6. The DP communication system of claim 1, wherein the optical element comprises a polarization beamsplitter and rotator.

7. The DP communication system of claim 1, wherein a path length from the first phase modulator to the optical element is substantially equal to a path length from the second phase modulator to the optical element.

8. The DP communication system of claim 1, comprising a traveling-wave modulator that comprises the first phase modulator and the second phase modulator, wherein the traveling-wave modulator comprises:
a first waveguide configured to receive the first input light;
a second waveguide configured to receive the second input light; and
a driver configured to:
apply a first electric field across the first waveguide to generate the first modulated input light; and
apply a second electric field across the second waveguide to generate the second modulated input light.

9. The DP communication system of claim 1, wherein the DP communication system is integrated on a single chip in silicon photonics.

10. The DP communication system of claim 1, wherein:
the first modulated input light is provided into a first optical transmission path and the second modulated input light is provided into a second optical transmission path, and
the first optical transmission path and the second optical transmission path are free from electronic control of a relative DC phase between the first optical transmission path and the second optical transmission path.

11. A DP communication system comprising:
a transmitter comprising:
a laser configured to emit light,
a splitter configured to split the light from the laser into a first input light and a second input light,
a first modulator configured to modulate the first input light with a first data stream to yield a first modulated input light and a second modulator configured to modulate the second input light with a second data stream to yield a second modulated input light, the second data stream complementary to the first data stream, and
an optical element comprising:
a first input configured to receive the first modulated input light substantially unmixed with the second modulated input light, and
a second input configured to receive the second modulated input light substantially unmixed with the first modulated input light, and
wherein the optical element is configured to cause the first modulated input light and the second modulated input light to have orthogonal polarizations, combine the first modulated input light and the second modulated input light into transmit light, and provide the transmit light into a transmission link; and
a receiver comprising:
an input port configured to receive light from the transmission link,
at least one second optical element configured to split the light from the transmission link into a first split light provided into a first optical transmission path and a second split light, with a different polarization in the transmission link, provided into a second optical transmission path, and
a 2×2 multi-input-multi-output (MIMO) demultiplexer configured to receive light from the first optical transmission path and the second optical transmission path.

12. The DP communication system of claim 11, wherein the first modulator and the second modulator are directly connected to the optical element.

13. The DP communication system of claim 11, wherein the transmit light comprises a substantially equal combination of the first modulated input light and the second modulated input light.

14. The DP communication system of claim 11, wherein the first modulator comprises a first tone marker configured to apply a tone in a bias voltage.

15. The DP communication system of claim 11, wherein the optical element comprises a polarization beamsplitter and rotator.

16. The DP communication system of claim 11, wherein the at least one second optical element comprises a polarization beamsplitter and rotator.

17. The DP communication system of claim 11, wherein the receiver comprises:
a pair of photodetectors comprising (i) a first photodetector configured to detect a first demultiplexed output from the optical 2×2 MIMO demultiplexer and output a first electrical signal into a first electrical transmission path, and (ii) a second photodetector configured to detect a second demultiplexed output from the optical 2×2 MIMO demultiplexer and output a second electrical signal into a second electrical transmission path.

18. A method of performing DP transmission, the method comprising:
generating light using a laser;
splitting the light from the laser into a first input light and a second input light;
modulating the first input light with a first data stream to yield a first modulated input light and modulating the second input light with a second data stream to yield a second modulated input light, the second data stream complementary to the first data stream;
receiving the first modulated input light substantially unmixed with the second modulated input light and receiving the second modulated input light substantially unmixed with the first modulated input light;
causing the first modulated input light substantially unmixed with the second modulated input light and the second modulated input light substantially unmixed with the first modulated input light to have orthogonal polarizations;
combining the first modulated input light and the second modulated input light into transmit light; and
providing the transmit light into a transmission link.

19. The method of claim 18, wherein the transmit light comprises a substantially equal combination of the first modulated input light and the second modulated input light.

20. The method of claim 18, wherein modulating the first input light and modulating the second input light occurs over substantially equal path lengths.
